(19) United States
(12) Patent Application Publication
(10) Pub. No.: US 2026/0141285 A1
(43) Pub. Date: May 21, 2026

(54) DEEP LEARNING MODEL FOR APPROXIMATING INVERSE-MATRIX OPERATIONS

(71) Applicant: HEWLETT PACKARD ENTERPRISE DEVELOPMENT LP, Spring, TX (US)

(72) Inventors: DAVID STRENSKI, Ypsilanti, MI (US); SREENIVAS RANGAN SUKUMAR, Seattle, WA (US); JORDAN NANOS, Spring, TX (US)

(21) Appl. No.: 18/948,866

(22) Filed: Nov. 15, 2024

(51) Int. Cl. G06N 20/00

(52) U.S. Cl. CPC G06N 20/00

(57) ABSTRACT

Systems and methods are provided for a model-centric approach that can be used to measure a computer's performance based on metrics obtained during and/or from training a machine learning (ML) model. Examples include building a training data set by generating first matrices and second matrices and deriving third matrices from the first and second matrices. Examples also include training, at a plurality of computer systems, a plurality of machine learning (ML) models by applying the first and third matrices to a plurality of ML algorithms and obtaining performance metrics based on training. The performance metrics can then be set as benchmarks for the plurality of computing systems to facilitate assessing a relative performance amongst the plurality of computing systems.

### BACKGROUND

In computing, a benchmarking is the act of running a computer program, a set of programs, or other operations, in order to assess the relative performance. The LINPACK Benchmarks are a measure of a system's floating-point computing power by measuring how fast a computer solves a dense system of linear equations. The latest version the LINPACK benchmarks, the High Performance LINPACK (HPL) benchmark, is used to rank the fastest computers in the world to build the Top500 list, which ranks the top 500 most powerful computer systems in terms of double-precision floating-point format (FP64).

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 depicts a schematic block diagram of an environment for training a machine learning model to predict function results, in accordance with the examples disclosed herein.

FIG. 2 is a flowcharts illustrating an example process for training an machine learning model to predict function results, in accordance with an example implementation of the present disclosure.

FIG. 3 depicts a schematic diagram of the process for generating training data samples and labeled data samples, in accordance with an example of the present disclosure.

FIG. 4 is a schematic illustrate of an example iteration for training a machine learning model on the training data samples and labeled data samples of FIG. 3.

FIG. 5 depicts a schematic block diagram of an environment for benchmarking a plurality of computing systems, in accordance with an example disclosed herein

FIG. 6 is an example computing component that may be used to implement various features of benchmarking performance of computing systems in accordance with the implementations disclosed herein.

FIG. 7 is an example computing component that may be used to train a ML model to predict inverse-matrix operations in accordance with the implementations disclosed herein

FIG. 8 is a computing component that may be used to implement examples of the disclosed technology.

The figures are not exhaustive and do not limit the present disclosure to the precise form disclosed.

### DETAILED DESCRIPTION

LINPACK is a software library package that performs numerical linear algebra operations. One of those operations is an inverse-matrix operation that solves for a vector [x] in the equation of matrix [A] times vector [x] equals vector [b] (i.e., [A][x]=[b]) by determining an inverse of matrix [A], i.e., inverse-matrix [A′]. Solving [A][x]=[b] can be used in the HPL benchmark used to rank the fastest computers in the world to build the Top500 list of the most power computer systems. The most recent Top500 computer systems takes about five hours on 30,000+GPUs (graphics processing units) to compute the operations in the HPL benchmark and can consume power on the order of megawatts in doing so. The HPL benchmark uses a computer-centric time-to-solution approach by measuring a number of 64-bit floating-point operations that a computer can perform per second (e.g., FLOPS) in reaching a solution. However, a computer's performance when running real-world applications tends to lag behind the performance reflected when running the LINPACK benchmarks. Additionally, the LINPACK benchmarks may not be ideal for distributed platforms, because the performance as measured by the LINPACK benchmarks, include the HPL benchmark, is typically lower the more nodes a computer system has due to communication overhead. Thus, the LINPACK benchmarks may not be practical for distributed or de-centralized computing systems.

Implementations of the technology disclosed herein provide a model-centric approach that can be used to measure a computer's performance based on metrics obtained during and/or from training a machine learning (ML) model to predict inverse-matrix operations by estimating vector [x] in [A][x]=[b] without relying on prior knowledge or input of actual mathematical operations. The technology disclosed herein can train an ML model to predict results (e.g., vector [x]) of inverse-matrix operations (e.g., [A][x]=[b]) using a matrix [A] and a vector [b] as inputs. The ML models are trained to recognize patterns in relationships between elements of matrix [A] and vector [b] to predict the result of the inverse-matrix operation, without having to resolve actual inverse of matrix [A]. Once trained, the ML model can significantly reduce the time-to-solution, and particularly in analog sub-precision processors, and transforming matrix inversion to an AI inference problem.

Conventionally, to compute a vector [x], one would provide the inverse-matrix [A′] of the matrix [A] and compute vector [x] as the result of matrix [b] times the inverse-matrix [A′]. However, computing the inverse-matrix [A′] can be difficult, time consuming, and impractical, particularly in the case of where matrix [A] is a sparse matrix, banded matrix, triangular matrix, or ill-conditioned matrix (e.g., such as the Hilbert matrix). In these cases, the computations to obtain an inverse-matrix could be prohibitively time consuming to perform via a computation device, let alone to do so manually. In fact, it is this process of computing an inverse-matrix [A′] and computing vector [x] as the result of matrix [b] times the inverse-matrix [A′] that is used in the LINPACK benchmarks. For example, the HPL benchmark uses a 27 million by 27 million element matrix as matrix [A], thus it can take the world's fastest computer 5 hours on 30,000+ GPUs consuming megawatts of power to solve. For a human to do the same, it would take decades, if not a lifetime. As such, it can be impractical to perform such operations. Particularly as the matrices involved become increasingly complex, such as, for example, in the case of a sparse matrix, banded matrix, triangular matrix, ill-conditioned matrix (e.g., such as the Hilbert matrix), and the like.

Accordingly, instead of spending the computation resources to obtain an inverse-matrix [A′], the technology disclosed herein trains an ML model to predict resultant output matrices (e.g., vector [x]) of matrix multiplication operations (e.g., [A] [x]=[b]) from matrix [A] and vector [b] as inputs. Thus, the examples herein need not perform an actual inverse-matrix operation and do not resolve an inverse-matrix [A′]. In examples, the disclosed technology trains an ML model by first building training data sets. Building training data sets may include generating a plurality of first matrices (e.g., a plurality of matrices [A]) and a plurality of second matrices (e.g., a plurality of vectors [x]). The examples execute a numerical operation on the plurality of first matrices and the plurality of second matrices to generate a plurality of third matrices (e.g., a plurality of vectors [b]). In an illustrative example, the plurality of first matrices can be multiplied with the plurality of second matrices to generate the plurality third matrices (e.g., each matrix [A] is multiplied with each vector [x] to generate corresponding vectors [b]). Entries of the matrices (and vectors) can be provided in any format, such as but not limited to, integers, decimals, binary, octal, hexadecimal, expressions, reals, fixed-point, floating-point, complex numbers, alphanumeric characters, or any other format as desired.

To train the ML models, examples herein can apply the training data set to an ML algorithm. For example, the plurality of first matrices (e.g., matrices [A]) and the plurality of third matrices (e.g., vectors [b]) may be applied to the ML algorithm as input training data samples, and the ML algorithm predicts a plurality of predicted output matrices (e.g., predicted vectors [x]). In examples, each iteration of training may include concatenating a first input matrix (e.g., a matrix [A]) with a third input matrix (e.g., a vector [b]) to generate input training data [A|b]. The ML algorithm may generate a predicted output matrix (e.g., a predicted vector [x]) from the input training data. The ML algorithm can compare the predicted output matrix to a second input matrix data (e.g., a vector [x]) associated with the first and third input matrices. The second input matrix may be labeled with the first and third input matrices associated therewith (e.g., the third input matrix generated from the first input matrix and the second input matrix). The third input matrix in this case may be referred to as labeled training data. In examples, the comparison may include measuring a similarity between the predicted output matrix and the labeled training data and use the measured similarity as a basis to adjust parameters (e.g., weights) of the ML algorithm. In examples, Euclidean Norm can be used to measure similarity; however, other techniques, such as but not limited to, cosine similarity, dot product, and hamming, may be used as desired for a given application.

As alluded to above, this training process can be used for benchmarking by providing performance benchmarks for computing systems, in place of the HPL benchmark. For example, a plurality of computing systems can execute separate instances of training, whereby computer system trains a ML model according to the above-described examples. Common training data may be used by each computer system. For example, training data sets can be built as described above and stored to a data store. Each computing system may obtain the same training data sets and apply it to individual instances of the same ML algorithm, thereby executing separate training instances. During each training instance, performance metrics can be obtained related to the respective training, such as an amount of time to execute the training, computation resource consumed (e.g., memory utilization, CPU utilization, GPU utilization, and/or network bandwidth) during the training, power consumed by the computing system during training, etc. One or more of these performance metrics can be set as benchmarks for each respective computing system and used to assess the performance of each computing system relative to the other computing systems.

By using performance metrics obtained during training as benchmarks of a computing system's performance, the technology disclosed herein can overcome the technical shortcomings of prior benchmarking approaches. For example, performance as measured during training may be more reflective of actual performance when running real-world applications. For example, using HPL may give a relative indication of only how well a computer system performs numerical simulation type codes, but not how well the computer system performs AI and/or ML tasks. The examples disclosed herein, can be used to provide a model-centric approach to better benchmark AI and/or ML related performance.

Additionally, solving dense systems of linear equations, such as [A][x]=[b], is applicable across a broad spectrum applications and technical fields and numerical simulations. For example, control systems, such as used for flights, robotics, autonomous vehicle control, and the like, that frequently rely on solving a dense system of linear equations to provide solutions and control inputs for autonomous operation. As another example, a dense system of linear equations is frequently used in telecommunications, for example, in signal processing for communication error correction and filtering. Additionally, financial modeling, simulations of real-world environment (e.g., weather forecasting), finite element analysis, and computational fluid dynamics, to name a few examples, each rely on solving dense systems of linear equations. The examples herein can be used to provide an efficient means for solving these dense systems of linear equations. For example, once the ML model is trained, the computation resource consumed during an inference is nominal compared to actually computing the solution according to conventional approaches. Results can therefore be computed in near real-time that can reduce time to solution for the various real-world applications.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

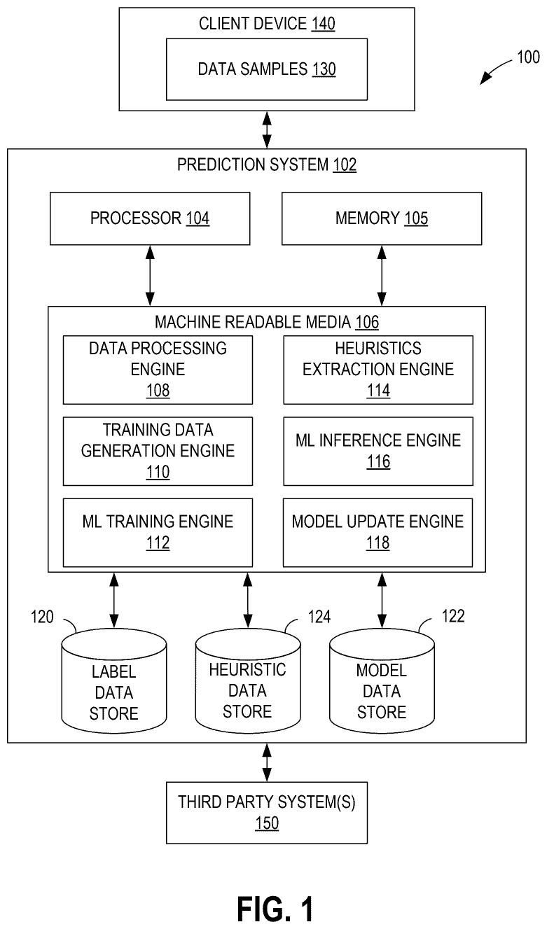

FIG. 1 depicts a schematic block diagram of an environment 100 for training a ML model to predict function results, in accordance with the examples disclosed herein. In the example of FIG. 1, predication system 102 comprises processor 104, memory 105, and machine readable media 106. Classification system 102 may be a server computer that communicates via network communications to other devices accessible on the network, including client device 140 and third party system 150. Prediction system 102 may receive input data samples 130 from client device 140 and/or third party system 150 in a distributed communication environment.

Processor 104 may comprise a general-purpose or special-purpose processing engine such as, for example, a microprocessor, controller, or other control logic. Processor 104 may be connected to a bus, although any communication medium can be used to facilitate interaction with other components of prediction system 102 or to communicate externally.

Memory 105 may comprise random-access memory (RAM) or other dynamic memory for storing information and instructions to be executed by processor 104. Memory 105 might also be used for storing temporary variables or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, and modules for implementing the functionality discussed herein. Machine readable media 106 may carry one or more sequences of one or more instructions processor 104 for execution. Such instructions embodied on machine readable media 106 may enable prediction system 102 to perform features or functions of the disclosed technology as discussed herein. For example, the interfaces, circuits, and modules of machine readable media 106 may comprise, for example, data processing module 108, training data generation engine 110, ML training engine 112, heuristics extraction engine 114, ML inference engine 116, and model update engine 118.

Data processing module 108 may be configured to receive data samples 130 from client device 140 and/or third party systems 150, including end user devices or software systems. The data samples 130 may be generated by client device 140 and/or third party systems 150. In some examples, the source of the data samples 130 may transmit the generated the data samples 130 via a network to prediction system 102 and processed by data processing module 108. The transmission of the data may be transmitted using different protocols like HTTP, MATT, or custom protocols specific to the application or industry of the particular embodiment. In some examples, the data is ingested by collecting, receiving, and storing the data.

In some examples, the data samples 130 received by the prediction system 102 comprises a plurality of first data samples and a plurality of second data samples. In an illustrative example, the plurality of first data samples comprise a plurality of first matrices (e.g., a plurality of matrices [A]), each comprising a set of first elements. In examples, the plurality of first matrices with dimensions K by J, where K and J are integers greater than 0. Thus, each of the plurality of first matrices may comprise K rows, J columns, and a K times J elements. The plurality of second matrices, in this example, comprise a plurality of second matrices, each comprising a set of second elements. In examples, the plurality of second matrices with dimensions L by J matrices, where L is an integer greater than 0. Thus, each of the plurality of second matrices may comprise L columns, J rows, and a number of L×J elements. In an illustrative example, the number L is one, such that the plurality of second matrices comprises a plurality of single column matrices (i.e., vectors. In examples, the plurality of vectors may be a plurality of vectors [x].

In examples, the data samples 130 received by the prediction system 102 may be generated randomly in accordance with a defined format. For example, a user may specify, via the client device 140 and/or third party system 150, a representation format from a set of representation format types. The representation format types may comprises integers, decimals, binary, octal, hexadecimal, expressions, reals, fixed-point, floating-point, complex numbers, alphanumeric character strings, and the like. As another example, a user may specify, via the client device 140 and/or third party system 150, a size of each data sample 130. For example, in the case of matrices, the number or rows and columns may be specified (e.g., numbers L, J, and K). In the above examples, data samples 130 may be randomly generated according to the specified representation format and size. In another example, various data samples 130 may be input into the client device 140 and/or third party systems 150 to construct the plurality of first data samples and the plurality of second data samples.

In some examples, the data samples 130 received by the prediction system 102 may be unlabeled data samples. For example, the plurality of first data samples and a plurality of second data samples may be unlabeled data samples. The information received with the data samples can include a data packet header according to a transmission protocol, payload (e.g., the data samples and identifiers), and/or metadata that is added during the transmission of the data. In this sense, the data packet header, payload, or metadata that is added during the transmission of the data may not correspond with a label added by prediction system 102 later in the process. Instead, any label added by prediction system 102 may correspond with data characteristics of the data samples and/or or relationships with other data samples that can identify the type of data upon analysis of the data packet. Any label added by prediction system 102 need not be provided with the data sample as it is received by prediction system 102.

In some examples, the data samples 130 received by the prediction system 102 may comprise labeled data samples. For example, in some implementations, the source of the data samples may generate a plurality of third data samples based on the plurality of first data samples and the plurality of second data samples. In this case, each first data sample can be combined with each second data sample to generate a corresponding third data sample. Labels can then be generated for each second data sample based on the first sample used with the respective second data sample to generate a corresponding third data sample. That is, for example, a first first data sample combined with a first second data sample may be used to generate a first third data sample. A label can be generated and assigned to the first second data sample that references the first first data sample and the first third data sample. If a second first data sample is combined with the first second data sample to generate a second third data sample, then another label can be generated and assigned to the first second data sample (e.g., the same first second data sample as in the preceding example) that references the second first data sample and the second third data sample. In another example, if the first first data sample is combined with a second second data sample to generate a third third data sample, then a label can be generated and assigned to the second second data sample that references the first first data sample and the third third data sample. In this way, each second data sample can be labeled with and associated to one or more pairs of first and third data samples.

As an illustrative example, a numerical operation can be executed on the plurality of first data samples and the plurality of second data samples to generate the plurality of third data samples. For example, a plurality of matrices [A] as the plurality of first data samples can be multiplied by a plurality of vectors as the plurality of second data samples to generate a plurality of vectors as the third plurality of data samples. That is, for example, a matrix [A] can be multiplied by a vector [x] to generate a vector [b]. The operation can be repeated for each vector [x] and each matrix [A], such that corresponding vector [b] is generated for each pair. Labels can then be generated and assigned to the vectors [x] that associates each vector [x] with one or more pairs of matrix [A] and vector [b]. For example, a matrix [A]₀ and vector [x]₀ may generate a vector [b]₀ and vector [x]₀ may be labeled with a reference to matrix [A]₀ and vector [b]₀. Similarly, a matrix [A]₁ and vector [x]₀ may generate a vector [b]₁ and vector [x]₀ may be also be labeled with a reference to matrix [A]₁ and vector [b]₁. And so on for each pair. As another example, implementations disclosed herein may be configured to iterate over N samples, where a random matrix [A]ᵢ and a random vector [x]ᵢ may be generated and used to create a vector [b]ᵢ.

In examples, the prediction system 102 may receive the data samples 130 as a multiple data sets constructed as a data structure. In this case, the data structure may comprise a first data set of the plurality of first data samples and a second data set of the plurality of data second samples. Each data sample therein may be associated with a unique identified, such as matrix [A]ᵢ and vector [b]_{z} where i and z are integers for indexing the data samples. In examples where prediction system 102 receives labeled data, the data structure may also comprise a third data set of the third data samples, e.g., a third data set of vectors [x]_{y} where y is an integer for indexing the data sample. The labels, if generated, correlating the plurality of second data samples to pairs of the plurality of first data samples and plurality of third data samples may be included as metadata, for example, in the data structure or as a separate data structure.

Training data generation engine 110 may be configured to generate training data and build training data sets. In one example, training data generate engine 110 may receive the data samples 130 from client device 140 and/or third party system 150. As described above, the data samples 130 received by the training data generate engine 110 may comprise the plurality of first data samples and the plurality of second data samples, for example, as a data structure. In some examples, the data samples received by the training data generate engine 110 may also comprise the plurality of third data samples. The data samples may be labeled or unlabeled. In this case, the training data generation engine 110 may build training data sets by storing the received data samples and labels (if any) in label data store 120.

In some implementations, training data generation engine 110 may be configured to generate the plurality of third data samples. For example, the training data generation engine 110 may generate the plurality of third data samples from a plurality of first data samples and a plurality of second data samples. In some cases, training data generation engine 110 may receive the plurality of first data samples and the plurality of second data samples from the client device 140 and/or third party systems 150. The plurality of third data samples can be generated and labeled as described above at the training data generation engine 110.

In another example, the training data generation engine 110 may be configured to generate the plurality of first data samples and the plurality of second data samples. For example, a representation format and a size of the data samples may be specified, as described above. The training data generation engine 110 may be configured to generate random data samples for the plurality of first and second data sample according to the specified format. Once the plurality of first data samples and the plurality of second data samples are generated, training data generation engine 110 can generate the plurality of third data samples in the manner described above, including labels for each of the plurality of second data samples. Once generated, the training data generation engine 110 may build training data sets from the various data samples by storing the data samples and labels in label data store 120.

ML training engine 112 may be configured to train one or more ML models. For example, ML training engine 112 may be configured to train a supervised model, in which the ML model is trained to make distinctions between labeled training data and unlabeled training data. This training allows the ML models to recognize patterns and ultimately operate autonomously without using labels, for example, during inference. The ML models trained by the ML training engine 112 may comprise a prediction model that classifies input data samples as a predicted output.

Various training methods are described herein and implementation of any of these training methods will not divert from the essence of the disclosure.

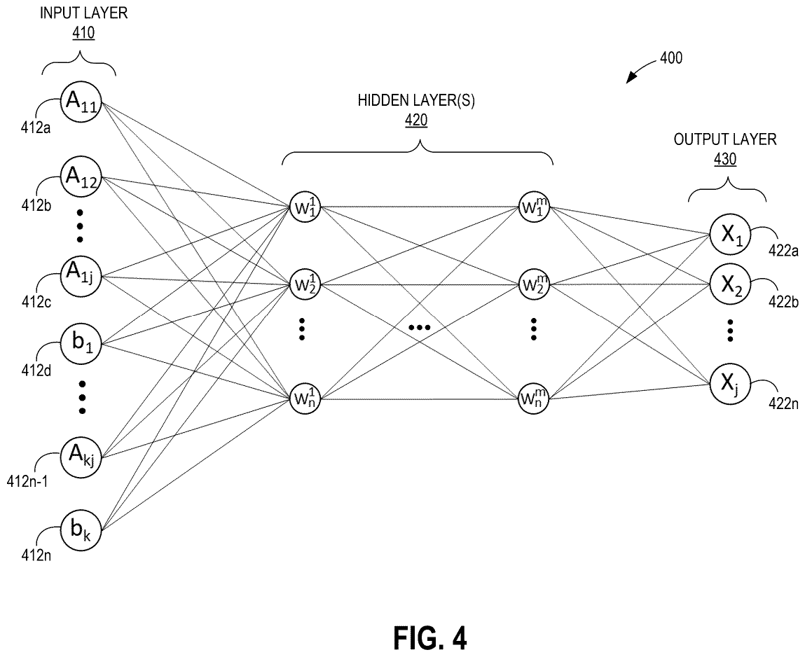

As noted above, ML training engine 112 may also be configured to train a supervised ML model. The supervised ML model may be trained using training data sets of training data samples stored in label data store 120. In some examples, the supervised ML model may correspond with linear regression, decision trees, support vector machines, neural networks, or other supervised ML models. The processing of the data samples in training may vary based on the type of model to be implemented on the unlabeled data. For example, in a neural network, the model may receive the training data sets as input and process it through layers of the neural network to generate an output result. The output of the neural network may provide determined similarities between features of output results and features of labeled data samples, which can be used to adjust model parameters (e.g., weights). An example of instance of training an ML model is provided below in connection with FIG. 4.

Training the supervised ML model may begin by initializing a ML algorithm with random or predefined parameters (e.g., weights) that can be adjusted during the training. The ML training engine 112 may iteratively adjust the parameters of the model to minimize the difference between predictions and labels treated as ground truth through backpropagation techniques. In some examples, a loss function may also be implemented to quantify the error between the predicted outputs and the true labels. The ML training engine 112 may iteratively adjusts the weights to minimize the loss function during training.

In some examples, an optimization function can be implemented to adjust the parameters of the model iteratively. An illustrative process to adjust the parameters is gradient descent, although various optimization functions may be implemented. In some examples, the gradient of the loss function may be calculated with respect to the parameters. The parameters may be updated in the opposite direction of the gradient to minimize the loss.

As an example, the ML training engine 112 may apply an input training data sample to the ML algorithm, which processes the input training data according to the parameters to predict a result. This predicted result can be compared against labeled training data and the difference therebetween used to adjust the parameters to minimize the difference. For example, for an iteration of training, the input training data sample may comprise a first data sample of the plurality of first data samples and a first data sample of the plurality of third data samples stored in the label data store 120. In examples, the training data generation engine 110 may combine the first data sample of the plurality of first data samples and the first data sample of the plurality of third data samples to generate an input training data sample. The ML training engine 112 may apply the input training data sample to the ML algorithm, which process the input training data to predict a result through a probabilistic prediction of the input training data sample to possible results or classes. The ML training engine 112 may compare the predicted result to a first data sample of the plurality of second data samples, stored in label data store 120, labeled with the first data sample of the plurality of first data samples and the first data sample of the plurality of third data samples. The ML training engine 112 may measure the similarity between the predicted result and the first data sample of the plurality of third data samples and the adjust parameters of the ML algorithm to minimize this difference through backpropagation techniques. The ML training engine 112 iterates through this process for each pair of first data samples and third data samples to iteratively adjust the parameters.

Examples herein may implement various confidence scores for probabilistic predications (or inferences). For example, a confidence score may be determined for each labeled data sample in label data store 120 and the greatest confidence score associated with the particular labeled data sample may be selected as the output for the input training data sample. In other examples, if a confidence score for a labeled data sample exceeds a predetermined threshold (e.g., 0.5 or 50%), the ML model might predict it as the output for the input training data. Otherwise, the ML model may predict that another labeled data sample is the output or that no labeled data sample exists for input training data, for example, where the confidence scores for all labeled data samples are below the predetermined threshold. In this sense, the thresholding of the confidence score may be used for prediction.

In examples, the training data generation engine 110 may generate the input training data samples by concatenating ones of the plurality of first data samples with ones of the plurality of third data samples to construct input training data samples. For example, for a given pair, elements of the first data sample of the plurality of first data samples of the plurality of first data samples can be linked together in a series with elements of the first data sample of the plurality of third data samples to generate input training data sample. The elements of each data sample may represent features of the resulting input training data sample. In an example where the plurality of first data samples are matrices (e.g., matrices [A]) and the plurality of third data samples are matrices (e.g., vectors [b]), elements of a matrix [A]₀ can be concatenated with elements of a vector [b]₀ produce an input training data sample having features comprising the elements of the matrix [A]₀ and the vector [b]₀. In one case, elements of a vector [b]₀ may be concatenated to the right of the elements of a matrix [A]₀. However, examples herein are not so limited. For example, elements of a vector [b]₀ may be concatenated below, above, to the left of, etc. the elements of a matrix [A]₀. The training data generation engine 110 can be configured to execute generate input training data samples for pairs of the plurality of first data samples and the plurality of third data samples.

In examples, the ML training engine 112 may use any desired technique to measure similarity between a predicted result and labeled training data. In some examples, Euclidean Norm can be used to measure similarity; however, other techniques may be used as desired for a given application. However, other techniques that may be used include, but are not limited to, cosine similarity, dot product, hamming, and the like. In any case, a predicted result may comprise elements that can be compared to elements of labeled training data to measure a similarity therebetween. Returning to the above example, input training data sample generated from matrix [A]₀ and vector [b]₀ may be applied to the ML algorithm to predict a result. This result may be compared to a vector [x]₀ associated with matrix [A]₀ and the vector [b]₀ via a label. Vector [x]₀ may comprise elements, which can be compared to the elements of the predicted result to measure the similarity therebetween.

The trained ML model may be stored in a model data store 122 as a trained ML model. The trained ML model may be used during an inference process when new unlabeled data samples are received by prediction system 102.

Heuristics extraction engine 114 may be configured to extract heuristic data during training of the ML model. In examples, the heuristics extraction engine 114 may extract heuristic data from the ML training engine 112 during and/or at the conclusion of the training process. For example, during the training process, the ML training engine 112 may compute performance metrics of the training. Performance metrics can be obtained related to the training, such as an amount of time to execute an iteration, a batch, or the entire training; computation resources consumed (e.g., memory utilization, CPU utilization, and/or GPU utilization) during the training; power consumed by the computing system during training; etc. The heuristic data may be stored in heuristic data store 124 as metadata associated with the trained ML model (e.g., as metadata).

In some examples, the ML training engine 112 may also be configured to verify the performance of the ML model during or at the conclusion of the training process. For example, a verification data set of may be generated in a manner similar to generating the input training data, as described above. For example, verification data set may comprise a plurality of first verification data samples (e.g., verification matrices [A]), a plurality of second verification data samples (e.g., verification vectors [x]), and a plurality of third verification data samples (e.g., verification vectors [b]) generated from pairs of the plurality of first verification data samples and plurality of second verification data samples. The plurality of third verification data samples can be labeled using the pairs of the plurality of first verification data samples and plurality of second verification data samples from which each of the plurality of third verification data samples was generated. The verification data set may be applied to the trained ML model and outputs checked against the labels to gauge the accuracy of the ML model. If the performance satisfies a desired threshold (e.g., 90% correctly classified or other desired performance), then the training process may be considered complete and the ML model stored to the model data store 122 for inferences.

ML inference engine 116, which is an optional component of prediction system 102, may be configured to initiate an inference process using the trained ML model stored in model data store 122. The trained ML model may make predictions on unlabeled input data samples. For example, once an ML model is trained, the ML model stored in model data store 122 can be deployed for inference of the new input data. In examples, ML inference engine 116 may generate labels that can be associated with or otherwise tagged to the prediction results of each inference.

The inference process may comprise, for example, providing the unlabeled input data samples to the trained ML model as input. The unlabeled input data samples may be a combination of a first input data sample and a second input data sample, which the trained ML model may process to provide an inference. The first and second input data samples, in some examples, may be an input matrix [A] and an input vector [b], which the trained ML model may process to predict an output vector [x]. Thus, by executing the ML inference engine 116 on input data, an output vector [x] can be predicted without having to compute an inverse-matrix [A′]. Instead, the trained ML model uses learned patterns and relations between elements of matrix [A] and vector [b] to predict a vector [x].

The processing of the data may vary based on the type of model to be implemented on the unlabeled data. For example, in a neural network, the model may receive the unlabeled data as input and process it through the layers of the neural network to generate an output. The output of the neural network may provide determined similarities between features of training data and features of new input data (e.g., whether the new data is similar or not similar to the training data with respect to a similarity threshold). In decision trees, the model may receive the unlabeled data as input and process it through its decision boundaries. In either of these implementations, the model may generate a prediction that on whether or not the unlabeled input data belongs to a class (e.g., a third data sample) corresponding to the similar training data based on similarities between features of the unlabeled input data and the training data. In some examples, the output may comprise a confidence score (also referred to as a probabilistic score) that the input data corresponds with the determined class (e.g., label of similar training data) or does not correspond with a class (e.g., outlier data). In examples where data samples are vectors or matrices, a feature of the data sample may be represented as an element of the matrix/vector.

Examples herein may implement various confidence scores. For example, a confidence score may be determined for each class (e.g., each output vector) and the greatest confidence score associated with the particular class may determine which class the input data sample is to be assigned. In other examples, if a confidence score for a class exceeds a predetermined threshold (e.g., 0.5 or 50%), the ML model might predict it as the belonging to the class. Otherwise, the ML model may predict the opposite (e.g., the input data does not belong to the class). In this sense, the thresholding of the confidence score may be used for predication.

The ML inference engine 116 may also be configured to generate a label for each inference. For example, where the ML inference engine 116 predicts an input data sample corresponds to a particular class (e.g., particular vector [x]), the ML inference engine 116 may generate and assign a label representative of the class to the input data sample. The label determined during the inference process may be stored in label data store 120.

Model update engine 118, which may be an optional component of classification system 102, may be configured to review outputs from the ML inference engine 116 and update the ML model based on the outputs. For example, the labels determined during the inference process executed by ML inference engine 116 may be provided back to the ML model to retrain the model during a subsequent training process. The retrained ML model may be stored in model data store 122 and/or provided for future inference processes on new input data samples that are received from, for example, client device 140 or third party system 150.

Once the ML model is trained, it can be used for solving dense systems of linear equations, such as [A][x]=[b], which are applicable across a broad spectrum applications and technical fields. For example, the inference made by the trained ML model can be used in control systems, such as used for flights, robotics, autonomous vehicle control, and the like, frequently rely on solving a dense system of linear equations to provide solutions and control inputs for autonomous operation. As another example, the inference made by the trained ML model can be used in telecommunications, for example, in signal processing for communication error correction and filtering. Additionally, financial modeling, simulations of real-world environment (e.g., weather forecasting), finite element analysis, and computational fluid dynamics, to name a few examples, can each utilize the inferences provided by the trained ML model.

In some examples, the ML inference engine 116 may be built into an application programming interface (API) call, which could be used by third party system(s) 150 to access and use the ML inference engine 116 for their application(s). That is, for example, once the ML model is trained, the ML inference engine 116 can be packaged into an API call for third party system calls.

Client device 140 may be configured to generate, transmit, and receive data from classification system 102. Client device 140 may be any end user device or software systems. The source of the data may comprise sensors, IoT devices, satellite, third party entities, or other end user devices. The data samples 130 may comprise a structured format, such as JSON, XML, or binary. In some examples, data samples 130 is ingested by collecting, receiving, and storing the data generated by client device 140.

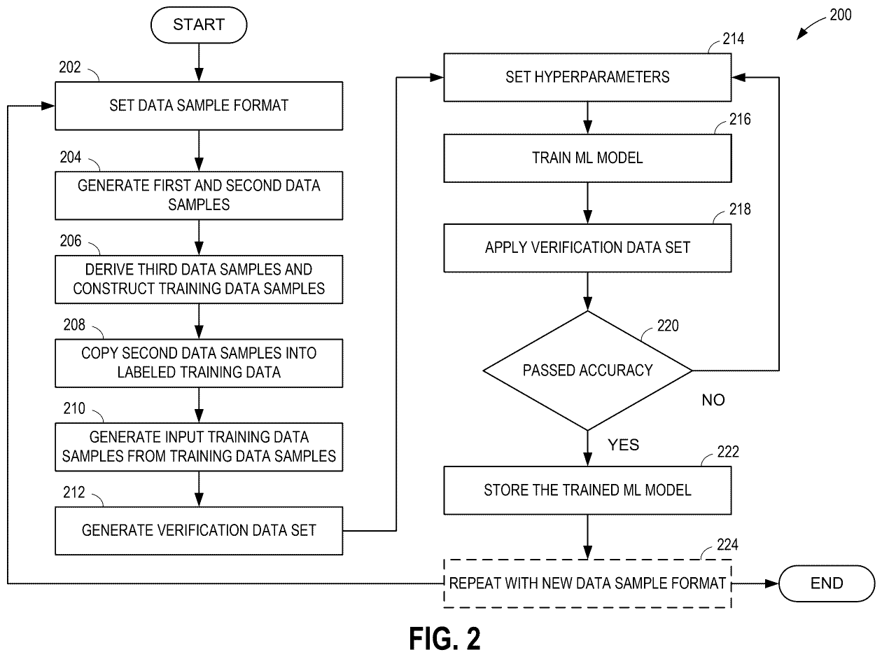

FIG. 2 is a flowcharts illustrating an example process 200 for training an ML model to predict function results, in accordance with an example implementation of the present disclosure. In examples, process 200 may be implemented as machine-readable instructions that may cause a processor to perform the operations described herein. In some examples, prediction system 102 may be implemented to execute one or more operations disclosed herein.

At operation 202, formats of data samples may be set. For example, operation 202 may include setting a representation format and a size of data samples. In examples, a user may be specify or otherwise selected the representation format and a size via an end-user device (e.g., client device 140 and/or third party system 150). In examples, the representation format may include, but not limited to, integers, decimals, binary, octal, hexadecimal, expressions, reals, fixed-point, floating-point, complex numbers, alphanumeric character strings, and the like. In examples, the data samples may comprise a plurality of first data samples and a plurality of second data samples. In this case, operation 202 may include setting a first format (e.g., first representation format and first size) for the plurality of first data samples and a second format (e.g., second representation format and second size) for the plurality of second data samples. In examples, the representation format for the first and second data samples may be the same.

At operation 204, a plurality of first data samples and a plurality of second data samples can be generated. For example, the plurality of first data samples and the plurality of second data samples can be generated randomly according to the format(s) set at operation 202. In examples, the plurality of first data samples and a plurality of second data samples may comprise matrices that are randomly generated using the format representation and sizes set at operation 202. For example, the plurality of first data samples may comprise a plurality of first matrices (e.g., a plurality of matrices [A]), each comprising a set of first elements. The plurality of second matrices, in this example, comprise a plurality of second matrices (e.g., a plurality of vectors [x]), each comprising a set of second elements. In examples, the plurality of first matrices may be K by J matrices and the plurality of second matrices are L by J matrices, where values of K, J, and L are specified at operation 202. In a case where the plurality of second matrices are vectors [x], L may be set to one. As described above, training data samples may be generated at the end-user device and/or at a remote server (e.g., prediction system 102).

At operation 206, training data samples are constructed by deriving a plurality of third data samples from the plurality of first and second data samples. That is, for example, a plurality of third data samples can be derived from the plurality of first and second data samples generated at operation 204, and training data samples can be constructed from the plurality of first and third data samples. For example, the plurality of third data samples can be created by combining the plurality of first data samples and the plurality of second data samples. Then ones of the plurality of third data samples can be combined with ones of the plurality of first data samples into ones of training data samples. More particularly, for example, each first data sample can be combined with each second data sample to generate respective third data samples. Each first data sample can be combined with the respective third data sample as a training data sample.

At operation 208, the plurality of second data samples are copied as labeled training data. For example, a label can be generated for each second data sample of the plurality of second data samples based on the first sample used with the respective second data sample to derive a respective third data sample. For example, operation 206 may include generating labels for each second data sample that references a training data sample that comprises a first data sample and the respective third data sample derived by combining the first data sample with the respective second data sample. In some examples, the label may reference the first data sample and the third data sample. The data samples can be stored in a data store (e.g., label data store 120) for subsequent use.

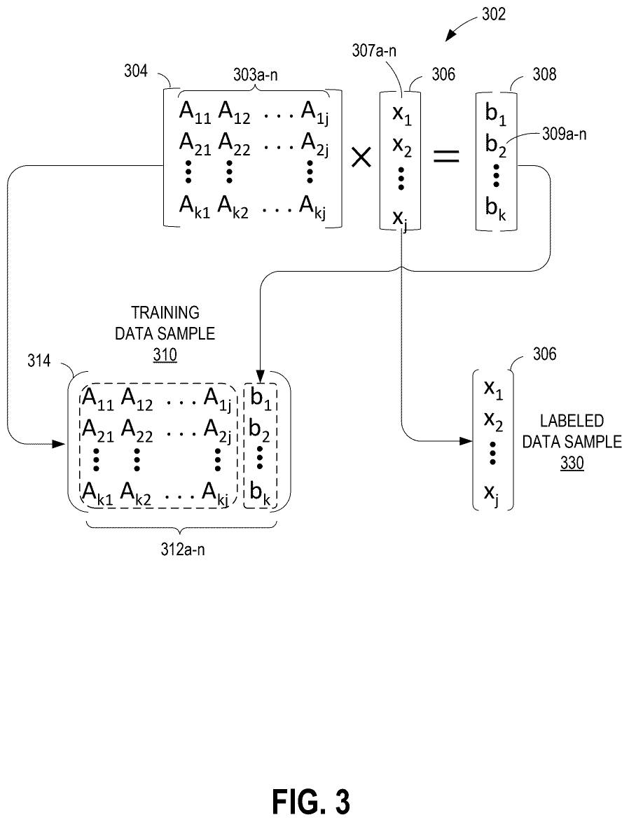

As an illustrative example of operations 204-208, FIG. 3 depicts a schematic diagram of the process for generating training data samples and labeled data samples, in accordance with an example of the present disclosure. FIG. 3 depicts a system of linear equations 302 that can be used to solve for a vector [x] 306 in the equation of matrix [A] 304 times vector [x] 306 equals vector [b] 308. In this example, matrix [A] 304 in this example comprises elements 303a-n, each of which may represent coefficients of the system of linear equations 302. Vector [x] 306, in this example, comprises elements 307a-n, each of which may represent variables of the system of linear equations 302. Vector [b] 308, in this example, comprises elements 309a-n, each of which may represent a constant term of the system of linear equations 302. In this example, matrix [A] 304 is an example of a first data sample of the plurality of first data samples, vector [x] 306 is an example of a second data sample of the plurality of second data samples, and vector [b] 308 is an example of a third data sample of the plurality of third data samples.

As described above, matrix [A] 304 and vector [x] 306 may be generated at operation 204 according to formats set at operation 202. In this case, operation 202 may set a number of rows K and a number of column J for matrix [A] 304 and a number of rows J and a number of columns to one for vector [x] 306. Operation 204 may then randomly generate matrix [A] 304 and vector [x] 306 according to the specified sizes. While not shown in FIG. 3, the elements 303a-n and 307a-n may be generated according to the representation format, e.g., as integers, decimals, binary, octal, hexadecimal, expressions, reals, fixed-point, floating-point, complex numbers, alpha-numeric characters, alphanumeric character strings, and the like.

At operation 206, vector [b] 308 is derived by combining matrix [A] 304 and vector [x] 306. For example, a numerical operation can be executed on matrix [A] 304 and vector [x] 306, such as matrix multiplication, to derive vector [b] 308. More particularly, for example, elements 303a-n of matrix [A] 304 can be multiplied by elements 307a-n of vector [x] 306 to generate elements 309a-n of vector [b] 308.

Operation 206 may generate training data sample 310 by combining the elements 303a-n of matrix [A] 304 and elements 309a-n of vector [b] 308 to form a matrix 314. In the example of FIG. 3, matrix 314 comprises elements 312a-n, which includes each of elements 303a-n and 309a-n arranged in a logical order. More particularly, elements 309a-n are added to respective rows of elements 312a-n, however any logical ordering may be employed as desired for a given application.

Operation 208 may generate a labeled data sample 330 by generating and assigning a label for vector [x] 306 and copying the copy the vector [x] 306 to a data store. The label associates vector [x] 306 with training data sample 310. For example, the labels may associate vector [x] 306 with matrix [A] 304 and vector [b] 308 (e.g., the vector derived from vector [x] 306 and matrix [A] 304).

Returning to FIG. 2, input training data samples can be generated by transforming the training data samples of operation 210 into sets of features for training the ML model. For example, operation 210 may combine elements of ones of the plurality of first data samples with ones of the plurality of third data samples to generate ones of input training data samples. That is, for example, a first data sample and a third data sample can be transformed into an input training data sample by combining elements of the first and third data sample to represent features of the input training data sample. In examples, the elements may be arranged in a series according to a desired logical sequence. More particularly, the elements may be arranged as a feature vector, where each entry of the feature vector is represented by an element of one of the first or third data samples. The ordering of the elements in the feature vector may be a logical and repeatable order, such that a similar arrangement or ordering can be used for each pair of first and third data samples.

In examples, the operation 210 may concatenate ones of the plurality of first data samples with ones of the plurality of third data samples to construct input training data samples. For example, for a given pair, elements of the first data sample of the plurality of first data samples and elements of the third data sample of the plurality of third data samples can be linked together in a series. In an illustrative example, shown in FIG. 4, elements of a given row index (e.g., row one in the case of matrix [A]) for the first data sample can precede elements of the same row (e.g., row one in the case of vector [b]) for the third data sample, followed by elements of a next row index (e.g., row two) for the first data sample, followed by elements of the next row index (e.g., row two) for the third data sample, and so on until the final row index (e.g., row K) for the third data sample. While the above example provides a specific order, any order may be implemented as desired. For example, elements of the third data sample may precede elements of the first data sample of a given row, all elements of the third data sample (or first data sample) may proceed the elements of the first data sample (or third data sample), and so on.

At operation 212, operations 204-210 can be repeated to generate a verification data set. The verification data set may include a number of verification data samples, each comprising a first verification data sample (e.g., a verification matrix [A]), a second verification data sample (e.g., a verification vector [x]), and a third verification data sample (e.g., a verification vector [b]). As described above, the third verification data sample may be derived from the first and second verification data samples and the second verification data sample may be labeled to reference the first and third verification data sample. The number of verification data samples may be a fraction of the number of input training data samples generated above. For example, the verification data sample may comprise 10% or less, 5% or less, or any desired percentage of the number of training data samples. For example, operations 204-210 may generate 100,000 input training data samples and corresponding labeled data samples, while operation 212 may generate 5,000 verification data samples and corresponding labeled data samples.

At operation 214, hyperparameters of the ML model to be trained may be set. For example, batch size, number of epochs, number of hidden layers, number of neurons per hidden layer, learning rate may be set to define the ML model. Other hyperparameters that may be set at operation 214 include, but are not limited to, a model activation function and a loss function. The batch size defines a number of input training data samples to be processed during the training of the ML model before the parameters of the ML algorithm are adjusted. The number of epochs defines the number of complete passes through the entire set of input training data to be performed. Each epoch may be divided into the number of batches, whereby the ML model can be trained on a batch of input training data (e.g., a batch comprises a number of input training data samples computed from the total number of input training data samples divided by the batch size), the parameters are updated at the end of a batch, and the training repeats for each batch until the entire epoch is processed. The learning rate may define an amount of adjustment that can be made to each parameter when updating the model parameters after a batch. For example, a step size of 0.0001 may define that each parameter can be adjusted by 0.0001 after each batch. The number of layers and number of neurons can be defined as desired for a given application, whereby increasing the number of layers and neurons may increase the time required for training with improved accuracy.

At operation 216, the ML model can be trained by iteratively applying input training data samples to the ML algorithm defined according to the hyperparameters set at operation 214. In examples, operation 216 may iteratively apply input training data sample to the ML algorithm defined by the hyperparameters, which processes the input training data according to parameters (e.g., weights) to predict a result. The predicted result can be compared against labeled training data and the difference therebetween used to adjust the parameters, according to the defined learning rate, to minimize the difference. For example, for an iteration of training, an input training data sample can be applied the ML algorithm, which process the input training data to predict a result through a probabilistic prediction of the input training data sample to possible results or classes. The predicted result is compared to a labeled data sample and the similarity between the predicted result and the labeled data sample is measured. The operation is repeated for each input training data sample of a given batch. At the end of a batch, parameters can be adjusted through backpropagation techniques to minimize differences between the predicted result and the labeled data sample. Operation 216 iterates through this process for each batch to iteratively adjust the parameters, and repeats the entire process for the number of epochs defined at operation 214.

In some examples, a loss function may also be implemented to quantify the error between the predicted outputs and the true labels. In this case, operation 214 may iteratively adjust the parameters to minimize the loss function during training. An optimization function can be implemented to adjust the parameters iteratively. An illustrative process to adjust the parameters is gradient descent, although various optimization functions may be implemented. In some examples, the gradient of the loss function may be calculated with respect to the parameters. The parameters may be updated in the opposite direction of the gradient to minimize the loss.

Training at operation 214 may vary based on the type of model to be implemented. For example, in a neural network, the ML model may receive an input training data sample and process it through a number of layers (defined at operation 214) of the neural network. In decision trees, the ML model may receive the input training data sample and process it through decision boundaries.

In examples, operation 216 may use any desired technique to measure similarity between a predicted result and labeled training data. In some examples, Euclidean Norm can be used to measure similarity; however, other techniques may be used as desired for a given application. However, other techniques that may be used include, but are not limited to, cosine similarity, dot product, hamming, and the like.

FIG. 4 is a schematic illustrate of an example iteration for training the ML algorithm according to operation 216. The neural network 400 comprises an input layer 410, one or more hidden layer(s) 420, and an output layer 430. The number of hidden layer(s) 420, and the number of neurons that make up each hidden layer 420 may be defined during operation 214, as described above.

In examples, for a given iteration, the input layer 410 feeds an input training data sample as a feature vector to the one or more hidden layers 420. For example, the input layer 410 may include input neurons 412a-412n, one for each feature of the feature vector. As an illustrative example, referring to the example of FIG. 3, a feature vector may be generated by concatenating elements 303a-n of matrix [A] 306 with elements 309a-n of vector [b] 308. Each neuron 412a-412n, in this example, may then include an element of the feature vector as shown in FIG. 4. That is, for example, the input neuron 412a may include a first element A₁₁ of matrix [A] 306, the input neuron 412b may include a second element A₁₂ of matrix [A] 306, so one until input neuron 412d includes the first element b₁ of vector [b] 308, and so one until the final element bₖ of vector [b] 308, which follows the final element Aₖⱼ of matrix [A] 306.

The input layer 410 feeds the input training data sample to the hidden layer(s) 420, which processes the input data to predict a result at output layer 430. More particularly, each element of the input layer 410 is feed to each neuron of a first hidden layer. The neurons each apply a respective weight (e.g., W₁¹ to Wₙ¹ in the case of the first hidden layer 420 of FIG. 4) to the inputs, aggregates (e.g., summation) the weighted signals, and produces a nonlinear response, which is represented by an activation function. Each neuron's output is then broadcasted to successive neurons, for example, of the next hidden layer 420 (if any) or the output layer 430. In the event that a next hidden layer 420 is present, the neurons of the next hidden layer apply respective weights to the inputs (e.g., outputs from the preceding hidden layer) and produced a non-linear response. This is repeated for each hidden layer. In one example, the non-linear activation functions may be a sigmoid function. In other examples, the non-linear activation functions may include, but are not limited to, a logistic function, a softmax function, and a Gaussian function. Any number of these techniques may be utilized to perform backpropagation.

The output layer 430 represents a predicted result as a set of nodes 422a-422n. In keeping with the example above, four output nodes 422a-422n represent elements defining a predicted vector [x]. The predicted vector [x], represented as nodes 422a-422n, can be compared to a labeled data sample corresponding to matrix [A] 306 and vector [b] 308, for example, labeled data sample 330 of FIG. 3. The predicted vector [x] is compared to the labeled data sample 310 to measure the similarity therebetween. In examples, the predicted vector [x] and the similarity may be stored in a data store for downstream use.

According to illustrative examples, training of the neural network 400 may utilize backpropagation based on the measured similarity. Backpropagation may be divided into two phases, propagation and weight update. During each propagation, training pattern inputs can be forward propagated through the neural network 400 to generate the output activations. Then the propagation's output activations can be back propagated through the neural network 400 using the training pattern's target in order to generate deltas (e.g., differences in similarity) of all outputs in the output layer 430 and neurons of the hidden layer(s) 420.

According to some examples, for each weight update in the hidden layer(s), two steps can be taken to ensure proper training. First, for each neuron, multiply the output delta and input activation to get a gradient of the respective weight. Second, bring the weight in the opposite direction of the gradient by subtracting the learning rate (as specified at operation 214) of it from the weight. The sign of the gradient of a weight indicates if the delta is increasing. Thus, the weight is updated in the opposite direction. Both steps can be repeated a number of times until the performance of the neural network 400 is satisfactory.

As described above, examples herein may utilize batch learning. In batch learning, a number of iterations (e.g., forward and backward propagations) are performed for the input training data samples of a given batch before the weights are updated. A small batch size might train faster, but with more communication traffic. While a larger batch size may reduce communication, but might take longer to train.

Returning to FIG. 2, at operation 218, the verification data set is applied to the ML model following training at operation 216 to check the ML model's accuracy. In examples, operation 218 may be initiated after training as completed for the number of epochs defined at operation 214. The verification data set can be applied in a manner similar to the input training data sample, as described above. For example, each verification data sample can be provided to input layer 410 of the ML model as a concatenation of a matrix [A] and vector [b]. The hidden layer(s) 420 may process the inputs according to trained weights and predict a resultant vector [x].

At decision operation 220, a determination is made as to whether or not the trained ML model passes an accuracy threshold. For example, the verification data set may be applied to the trained ML model and outputs checked against labels of the verification data set to gauge the accuracy of the ML model. The verification data set comprises data samples that the ML model has not yet seen. If the accuracy satisfies a desired threshold (e.g., 90% correctly classified or other desired performance), then the ML model can be considered to have passed the accuracy threshold. In the above example, the resultant vector [x] can be compared to a labeled vector [x] by measuring the similarity therebetween.

If the determination at decision operation 220 is negative, the process 200 repeats operations 214-218. In some examples, the hyperparameters may be adjusted to improve accuracy.

If the determination at decision operation 220 is affirmative, the process 200 proceeds to operation 222 and stores the trained ML model for subsequent inferences. In examples, the trained ML model can be stored to a data store. In examples, operation 222 may include extracting heuristic data representative of the computer systems performance in executing operation 216. For example, heuristic data may include certain performance metrics related to the executing operation 216, such as but not limited to, an amount of time to execute an iteration, a batch, or the entire training; computation resources consumed (e.g., memory utilization, CPU utilization, and/or GPU utilization) during the training; power consumed by the computing system during training; etc. The heuristic data may be stored to the data store.

At optional operation 224, the process 200 may be repeated for a new data sample format if desired. For example, a representation format and/or data sample size may be updated and a new ML model can be trained according to the updated data sample format.

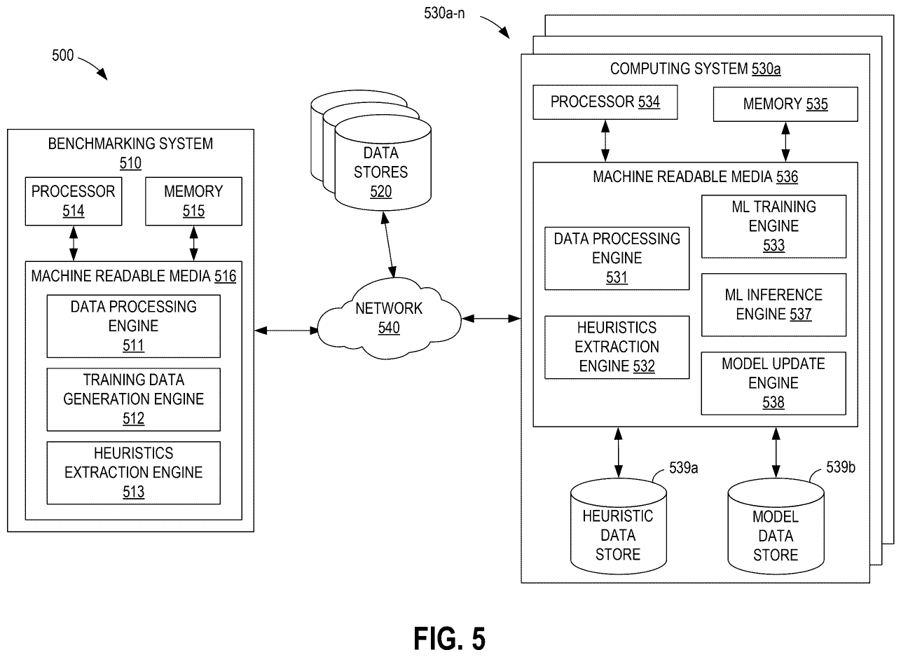

FIG. 5 depicts a schematic block diagram of an environment 500 for benchmarking a plurality of computing systems, in accordance with an example disclosed herein. In the example of FIG. 5, environment 100 comprises a benchmarking system 510 communicably connected to a plurality of computing systems 530a-n (herein referred to collectively as computing systems 530 or individually as computing system 530) via a network 540.

Benchmarking system 510 comprises processor 514, memory 515, and machine readable media 516. Benchmarking system 510 may be a server computer that communicates via network communications to other devices accessible on the network 540, including computing systems 530. In some examples, benchmarking system 510 may include multiple processors and/or accelerators. Similarly, computing system 530a, as an illustrative example of computing systems 530, comprises processor 534, memory 535, and machine readable media 536. Computing system 530a may be a server computer that communicates via network communications to other devices accessible on the network 540. In examples, benchmarking system 510 and/or computing system 530a may be configured to communicate with end-user devices (e.g., client device 140 and/or third party systems 150) via network 540.

Processors 514, 534 may comprise a general-purpose or special-purpose processing engine such as, for example, a microprocessor, controller, or other control logic. Processors 514, 534 may be connected to a bus, although any communication medium can be used to facilitate interaction with other components of benchmarking system 510 or computing system 530a, respectively, or to communicate externally.

[symbol]

Memories 515, 535 may comprise random-access memory (RAM) or other dynamic memory for storing information and instructions to be executed by processors 514, 534, respectively. Memories 515, 535 might also be used for storing temporary variables or other intermediate information during execution of instructions to be executed by processors 514, 534, respectively. Memories 515, 535 may also comprise a read only memory (“ROM”) or other static storage device coupled to a bus for storing static information and instructions for processors 514, 534, respectively.

Machine readable media 516, 425 may comprise one or more interfaces, circuits, and modules for implementing the functionality discussed herein. Machine readable media 516, 536 may carry one or more sequences of one or more instructions processor 514, 534, respectively, for execution. Such instructions embodied on machine readable media 516, 425 may enable benchmarking system 510 or computing system 530a, respectively, to perform features or functions of the disclosed technology as discussed herein. In an example, the interfaces, circuits, and modules of machine readable media 516 may comprise data processing module 511, training data generation engine 512, and heuristics extraction engine 513. The interfaces, circuits, and modules of machine readable media 536, in this example, may comprise, data processing module 531, ML training engine 533, heuristics extraction engine 532, ML inference engine 537, and model update engine 538.

In examples, the interfaces, circuits, and modules of machine readable media 516 may be similar to the interfaces, circuits, and modules of machine readable media 106 of FIG. 1. For example, data processing module 511, training data generation engine 512, and heuristics extraction engine 513 may be configured to perform the functionality described above in connection with data processing module 108, training data generation engine 110, and heuristics extraction engine 114, respectively.

For example, data processing module 511 may be configured to receive data samples from end-user devices and/or third-party systems.

Likewise, training data generation engine 512 may be configured to generate training data and build training data sets as described above in connection with training data generation engine 110. That is, for example, training data generation engine 512 may generate a plurality of first data samples, a plurality of second data samples, and a plurality third data samples (including labels) as described above. The data samples may be stored to a data store local to benchmarking system 510 and/or data store 520 (e.g., a cloud-based data storage).

Heuristics extraction engine 532 may be configured to extract heuristic data related to training ML models on the plurality of computing systems 530. For example, the heuristics extraction engine 532 may request and receive heuristic data from each computing system 530 related to training an instance of a common ML algorithm using the training data sets generated by training data generation engine 512. As described below, each computing system 530 trains instances of the common ML algorithm on the same training data set and computes performance metrics of the training. These performance metrics can be obtained by the heuristics extraction engine 532 and used to provide performance benchmarks for computing systems 530. Performance metrics can include, but not limited to, an amount of time to execute the training per each computing system 530, computation resource consumed (e.g., memory utilization, CPU utilization, and/or GPU utilization) during the training per each computing system 530, power consumed by the computing system during training per each computing system 530, etc. Heuristics extraction engine 532 can set one or more of these performance metrics as benchmarks for each respective computing system 530 and used to assess the performance of each computing system 530 relative to the other computing systems 530.

In examples, the interfaces, circuits, and modules of machine readable media 536 may be similar to the interfaces, circuits, and modules of machine readable media 106 of FIG. 1. For example, data processing module 531, ML training engine 533, heuristics extraction engine 532, ML inference engine 537, and model update engine 538 may be configured to perform the functionality described above in connection with data processing module 108, ML training engine 112, heuristics extraction engine 114, ML inference engine 116, and model update engine 118, respectively.

For example, data processing module 511 may be configured to receive (or obtain) training data sets from data store 520 and/or benchmarking system 510. The training data sets may be those generated by the training data generation engine 512. The training data sets may be transmitted using different protocols like HTTP, MATT, or custom protocols specific to the application or industry of the particular embodiment. In some examples, the data is ingested by collecting, receiving, and storing the data.

ML training engine 533 may be substantively similar to ML training engine 112 of FIG. 1. For example, the ML training engine 533 may be configured to train one or more ML models using the training data sets generated by the training data generation engine 512. The ML training engine 533 may execute the training as described above in connection with FIG. 1 and/or FIG. 2 in order to train an instance of the common ML algorithm by applying the training data sets. As such, the descriptions above with respect to ML training engine 112 and/or process 200 apply equally to ML training engine 533. ML training engine 533 stores the trained ML model to model data store 539b.

Each computing system 530 executes its respective ML training engine 533 to train an instance of the common ML algorithm using the training data sets generated by the training data generation engine 512. Thus, each computing system 530 may function to train a common ML model using isolated training instances, which can serve to provide insights on performance metrics for benchmarking each computing system.

Heuristics extraction engine 532 may be substantively similar heuristics extraction engine 114 of FIG. 1. For example, heuristics extraction engine 532 may be configured to extract heuristic data during training of the ML model by ML training engine 533. Performance metrics can be obtained related to the training, such as an amount of time to execute an iteration, a batch, or the entire training; computation resources consumed (e.g., memory utilization, CPU utilization, and/or GPU utilization) during the training; power consumed by the computing system during training; etc. The heuristic data may be stored in heuristic data store 539a as metadata associated with the trained ML model (e.g., as metadata). As described above, the heuristics extraction engine 532 of the benchmarking system 510 may be configured to obtain the heuristic data may be stored in heuristic data store 539a from each computing system 530, which can be used to set benchmarks for each computing systems 530.

ML inference engine 537 may be substantively similar to ML inference engine 116 of FIG. 1. For example, the ML inference engine 537, which is an optional component, may be configured to initiate an inference process using the trained ML model stored in model data store 539b. As described above in connection with FIG. 1, the trained ML model may make predictions on unlabeled input data samples. For example, once an ML model is trained, the ML model stored in model data store 539b can be deployed for inference of the new input data. In examples, ML inference engine 116 may generate labels that can be associated with or otherwise tagged to the prediction results of each inference. Thus, by executing the ML inference engine 538 on new input data in an illustrative example, an output vector [x] can be predicted without having to compute an inverse-matrix [A′]. Instead, the trained ML model uses learned patterns and relations between elements of matrix [A] and vector [b] to predict a vector [x]. In some examples, the predicted vector [x] may be an approximation of the actual vector [x] for matrix [A] and vector [b].

In some examples, the ML inference engine 537 may be built into an API call, which could be used by third party system(s) to access and use the ML inference engine 537 for their application(s). That is, for example, once the ML model is trained, the ML inference engine 537 can be packaged into an API call for third party system calls.

In examples, the trained ML model can be applicable across a broad spectrum applications and technical fields and numerical simulations. For example, the inference made by the trained ML model can be used in control systems, such as used for flights, robotics, autonomous vehicle control, and the like, frequently rely on solving a dense system of linear equations to provide solutions and control inputs for autonomous operation. As another example, the inference made by the trained ML model can be used in telecommunications, for example, in signal processing for communication error correction and filtering. Additionally, financial modeling, simulations of real-world environment (e.g., weather forecasting), finite element analysis, and computational fluid dynamics, to name a few examples, can each utilize the inferences provided by the trained ML model.

ML update engine 538 may be substantively similar to ML update engine 118 of FIG. 1. Thus, the description above in connection with ML update engine 118 applies equally to ML update engine 538.

The network 540 may be a public or private network, such as the Internet, or another communication network to allow connectivity among the benchmarking system 510 and computing systems 530. The network 540 may include third-party telecommunication lines, such as phone lines, broadcast coaxial cable, fiber optic cables, satellite communications, cellular communications, and the like. The network 540 may include any number of intermediate network devices, such as switches, routers, gateways, servers, and/or controllers, which are not directly part of the environment 500 but that facilitate communication between the various parts of the environment 500, and between the environment 500 and other network-connected entities.

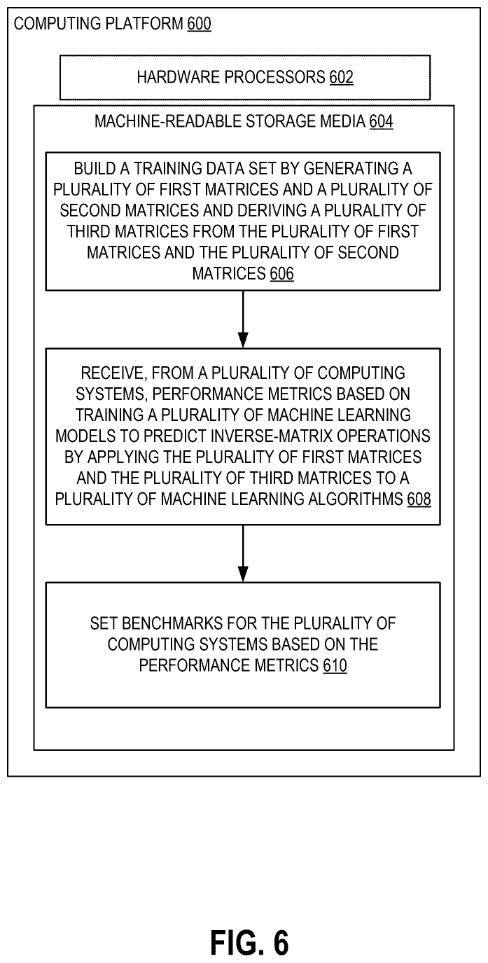

FIG. 6 illustrates a computing component that may be used to implement benchmarking performance of computing systems in accordance with various examples of the disclosed technology. Referring now to FIG. 6, computing component 600 may be, for example, a server computer, a controller, or any other similar computing component capable of processing data. In the example implementation of FIG. 6, the computing component 600 includes a hardware processor 602, and machine-readable storage medium for 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-610, to control processes or operations disclosed herein. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-610.

Hardware processor 602 may execute instruction 606 to build a training data set by generating a plurality of first matrices and a plurality of second matrices and deriving a plurality of third matrices from the plurality of first matrices and the plurality of second matrices. In examples, the plurality of first matrices and the plurality of second matrices may be a plurality of matrices [A] and a plurality of vectors [x], as described above in connection with FIGS. 1-5. In examples, the plurality of third matrices may be a plurality of vectors [b] that can be derived from the plurality of first matrices and the plurality of second matrices. In examples, as described above in connection with FIGS. 1-5, the plurality of second matrices may be labeled with ones of the plurality of first matrices and ones of the plurality of third matrices, where the ones of the plurality of third matrices are those that are derived from pairs comprising ones of the plurality of first matrices and ones of the plurality of second matrices. In examples, the plurality of first matrices may include one or more of a sparse matrix, a banded matrix, a triangular matrix, or an ill-conditioned matrix. Additionally in some examples, one or more of the plurality of first matrices and the plurality of second matrices may include entries (or elements) represented in one of binary, octal, hexadecimal, reals, fixed-point, floating-point, complex numbers, alphanumeric character strings, or the like.

In examples, hardware processor 602 may execute instruction 606 to create input training data. For example, the plurality of first matrices and the plurality of third matrices can be transformed into input training data by combining each of the plurality of first matrices with ones of the plurality of third matrices. Additional details are provided above in connection with FIGS. 1-5.

Hardware processor 602 may execute instruction 608 to receive, from a plurality of computing systems, performance metrics based on training a plurality of ML models to predict inverse-matrix operations by applying the plurality of first matrices and the plurality of third matrices to a plurality of ML algorithms. In examples, the plurality of computing systems may be, for example, computing systems 530a-n of FIG. 5.

In some examples, as described above in connection with FIG. 5, the plurality of ML algorithms may be a plurality of instances of a common ML algorithm. In this case, each computing system may be configured to apply the plurality of first matrices and the plurality of third matrices to an instance of the common ML algorithm.

In some examples, the plurality of second matrices comprises a plurality of first vectors, and the plurality of third matrices comprises a plurality of second vectors. In this example, the plurality of second vectors may be computed by executing instructions 606 to execute a numerical operation on the plurality of first matrices and the plurality of first vectors. In this case, training the plurality of ML models comprises may include predicting a plurality of output vectors by inputting the plurality of first matrices and the plurality of second vectors to the plurality of ML algorithms and determining a measure of similarity between the plurality of output vectors and the plurality of first vectors, as described above in connection with FIGS. 1-5. Parameters (or weights) of the ML algorithm may then be updated based on the measure of similarity, as described above.

Hardware processor 602 may execute instruction 610 to set benchmarks for the plurality of computing systems based on the performance metrics. As described above in connection with FIG. 5, the performance metrics may include one or more of: an amount of time to train each of the plurality of ML models, computation resource consumed while training each of the plurality of ML models, or power consumed while training plurality of ML models. In examples, setting the benchmarks may facilitate assessing relative performance amongst the plurality of computing systems, for example, by comparison amongst the benchmarks.

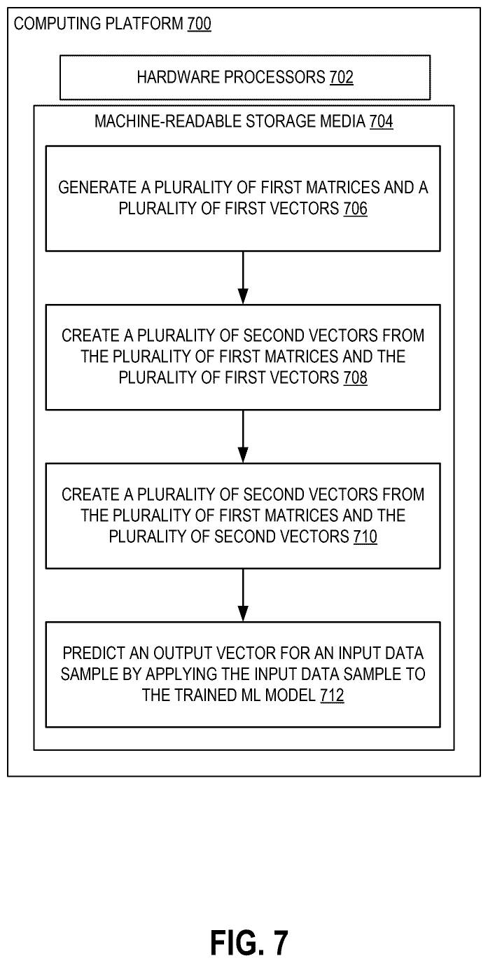

FIG. 7 illustrates a computing component that may be used to train a ML model to predict inverse-matrix operations in accordance with various examples of the disclosed technology. Referring now to FIG. 7, computing component 700 may be, for example, a server computer, a controller, or any other similar computing component capable of processing data. In the example implementation of FIG. 7, the computing component 700 includes a hardware processor 702, and machine-readable storage medium for 704.

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 706-712, to control processes or operations disclosed herein. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-712.

Hardware processor 702 may execute instruction 706 to generate a plurality of first matrices and a plurality of first vectors. In some examples, the plurality of first matrices and the plurality of first vectors are randomly generated, for example, according to user specified formatting (e.g., representation format and sizes). In various example, as described above in connection with FIGS. 1-4, the plurality of first matrices and the plurality of first vectors may correspond to a dense system of linear equations. In this case, the plurality of first matrices may be a plurality of matrices [A] comprising coefficients of the system of linear equations and the plurality of first vectors may be a plurality of vectors [x] comprising variables of the system of linear equations.

Hardware processor 702 may execute instruction 708 to create a plurality of second vectors from the plurality of first matrices and the plurality of first vectors. In some examples, the plurality of second vectors can be computed by multiplying the plurality of first matrices with the plurality of first vectors, as described above in connection with FIGS. 1-4. In various example, as described above in connection with FIGS. 1-4, the plurality of second vectors may be a plurality of matrices [b] comprising constant terms of the system of linear equations.’

Hardware processor 702 may execute instruction 710 to train an ML model to classify input data samples as output vectors by applying the plurality of first matrices and the plurality of second vectors to an ML algorithm. For example, hardware processor 702 may execute instruction 710 (or instruction 708) to build a training data set. In this case, the plurality of first matrices and the plurality of second vectors can be transformed, as described above in connection with FIGS. 1-4, to input training data by combining elements of the plurality of first matrices with elements of ones of the plurality of second vectors, which can be applied to the to the ML algorithm. For each first vector of the plurality of first vectors, a label can be generated and assigned to the respective first vector. This label may include or reference the first matrix of the plurality of first matrices and a second vector of the plurality of second vectors derived from the first matrix and the respective first vector.

The ML model, in this example, can be trained by applying the input training data to the ML algorithm. The ML model may predict a plurality of output vectors based on this application and measure a similarity between the plurality of output vectors and the plurality of first vectors based on labels assigned to the plurality of first vectors, for example, as described above in connection with FIGS. 1-4. Parameters of the ML algorithm may be updated based on the measured similarity.

In some examples, as described above, a performance metric of training the ML model can be determined. The performance metric may include one or more of: an amount of time to train the ML model, computation resource consumed while training the ML model, or power consumed while training the ML model, among other performance metrics as desired. The determined performance metrics can be used a performance benchmark to gauge performance of the computing platform 600 relative to other computing platforms.

Hardware processor 702 may execute instruction 712 to predict an output vector for an input data sample by applying the input data sample to the trained ML model.

In examples, the trained ML model can be applicable across a broad spectrum applications and technical fields. For example, the predictions made by the trained ML model can be used in control systems, such as used for flights, robotics, autonomous vehicle control, and the like, that frequently rely on solving a dense system of linear equations to provide solutions and control inputs for autonomous operation. As another example, the predictions made by the trained ML model can be used in telecommunications, for example, in signal processing for communication error correction and filtering. Additionally, financial modeling, simulations of real-world environment (e.g., weather forecasting), finite element analysis, and computational fluid dynamics, to name a few examples, can each utilize the predictions provided by the trained ML model.

The foregoing examples described in connection with FIGS. 1-7, are described with reference to inverse-matrix operations. However, the examples disclosed herein may be expanded to other functions and operations as desired for a given application. For example, the examples disclosed above may be used to train an ML model to predict results of Fast Fourier Transforms, Laplace Transforms, Stieltjes transformations, Wavelet Transforms, etc.

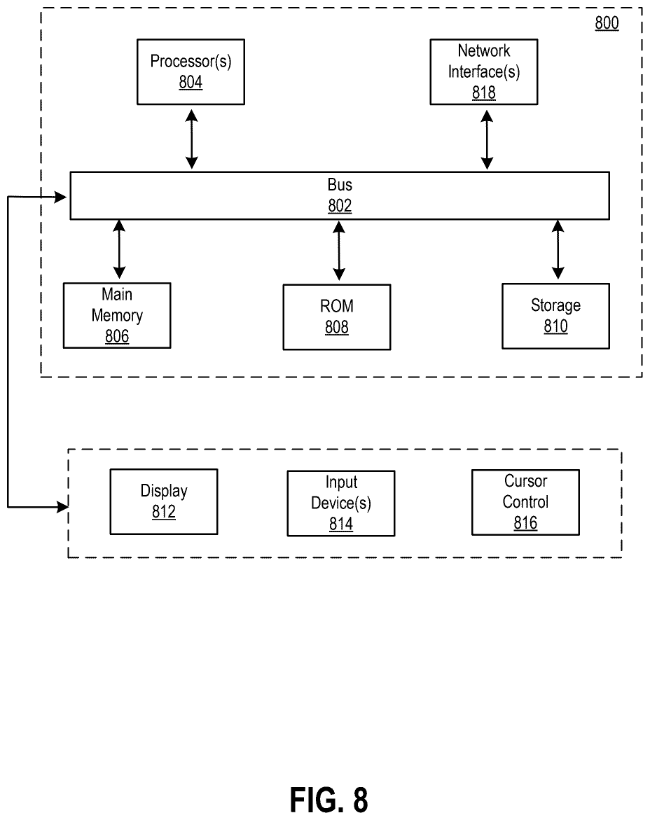

FIG. 8 depicts a block diagram of an example computer system 800 in which various examples of the disclosed technology described herein may be implemented. The computer system 800 includes a bus 802 or other communication mechanism for communicating information, one or more hardware processors 804 coupled with bus 802 for processing information. Hardware processor(s) 804 may be, for example, one or more general purpose microprocessors. The computer system 8000 may be implemented as one or more component of the environment 100 of FIG. 1 (e.g., prediction system 102, client device 140, and/or third party systems 150) and/or environment 500 of FIG. 5 (e.g., benchmarking system 510, computing systems 530a-n, and/or data stores 520).

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions. For example, main memory 806 may store instructions, that when executed by processor(s) 804, cause computer system 800 to perform one or more of the operations described in connection with FIGS. 2, 6, and/or 7.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some examples, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one example of the disclosed technology, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

The computer system 800 also includes a network interface 818 (also referred to as a communication interface) coupled to bus 802. Network interface 818 provides a two-way data communication coupling to one or more network links that are connected to one or more local networks. For example, communication interface 818 may be an integrated services digital network (ISDN) card, cable modem, satellite modem, or a modem to provide a data communication connection to a corresponding type of telephone line. As another example, network interface 818 may be a local area network (LAN) card to provide a data communication connection to a compatible LAN (or WAN component to communicate with a WAN). Wireless links may also be implemented. In any such implementation, network interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 818, which carry the digital data to and from computer system 800, are example forms of transmission media.

The computer system 800 can send messages and receive data, including program code, through the network(s), network link and network interface 818. In the Internet example, a server might transmit a requested code for an application program through the Internet, the ISP, the local network and the network interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
building a training data set by generating a plurality of first matrices and a plurality of second matrices and deriving a plurality of third matrices from the plurality of first matrices and the plurality of second matrices;
receiving, from a plurality of computing systems, performance metrics based on training a plurality of ML models to predict inverse-matrix operations by applying the plurality of first matrices and the plurality of third matrices to a plurality of ML algorithms; and
setting benchmarks for the plurality of computing systems based on the performance metrics, wherein setting the benchmarks facilitates assessing a relative performance amongst the plurality of computing systems.

2. The method of claim 1, wherein the plurality of ML algorithms are a plurality of instances of a common ML algorithm, and wherein each computing system applies the plurality of first matrices and the plurality of third matrices to an instance of the common ML algorithm.

3. The method of claim 1, wherein the plurality of second matrices comprises a plurality of first vectors, and wherein the plurality of third matrices comprises a plurality of second vectors.

4. The method of claim 3, further comprising:
computing the plurality of second vectors by executing a numerical operation on the plurality of first matrices and the plurality of first vectors;
wherein training the plurality of ML models comprises:
predicting a plurality of output vectors by inputting the plurality of first matrices and the plurality of second vectors to the plurality of ML algorithms;
determining a measure of similarity between the plurality of output vectors and the plurality of first vectors; and
updating weights of the ML algorithms based on the measure of similarity.

5. The method of claim 3, wherein the plurality of first matrices, the plurality of second matrices, and the plurality of third matrices correspond to a system of linear equations, wherein the plurality of first matrices comprises coefficients of the system of linear equations, wherein the plurality of first vectors comprises variables of the system of linear equations, and wherein the plurality of second vectors comprises constant terms of the system of linear equations.

6. The method of claim 1, further comprising:
transforming the plurality of first matrices and the plurality of third matrices to input training data by combining each of the plurality of first matrices with ones of the plurality of third matrices.

7. The method of claim 1, wherein the plurality of first matrices comprises one or more of: a sparse matrix, a banded matrix, a triangular matrix, or an ill-conditioned matrix.

8. The method of claim 1, wherein one or more of the plurality of first matrices and the plurality of second matrices comprises entries represented in one of binary, octal, hexadecimal, reals, fixed-point, floating-point, complex numbers, or alphanumeric character strings.

9. The method of claim 1, wherein the performance metrics comprise one or more of: an amount of time to train each of the plurality of ML models, computation resource consumed while training each of the plurality of ML models, or power consumed while training plurality of ML models.

10. A system, comprising:
a memory storing instructions; and
a processor communicably coupled to the memory and configured to execute the instructions to:
build a training data set by generating a plurality of first matrices and a plurality of second matrices and deriving a plurality of third matrices from the plurality of first matrices and the plurality of second matrices;
receive, from a plurality of computing systems, performance metrics based on the plurality of computing systems training a plurality of machine learning (ML) models to predict inverse-matrix operations by applying the plurality of first matrices and the plurality of third matrices to instances of a common ML algorithm; and
set benchmarks for the plurality of computing systems based on the performance metrics.

11. The system of claim 10, wherein the plurality of second matrices comprises a plurality of first vectors, and wherein the plurality of third matrices comprises a plurality of second vectors.

12. The system of claim 11, wherein the processor is further configured to execute the instructions to:
compute the plurality of second vectors by executing a numerical operation on the plurality of first matrices and the plurality of first vectors;
wherein training the plurality of ML models comprises:
predicting a plurality of output vectors by inputting the plurality of first matrices and the plurality of second vectors to the plurality of ML algorithms;
determining a measure of similarity between the plurality of output vectors and the plurality of first vectors; and
updating weights of the ML algorithms based on the measure of similarity.

13. The system of claim 10, wherein the processor is further configured to execute the instructions to:
transform the plurality of first matrices and the plurality of third matrices to input training data by combining each of the plurality of first matrices with ones of the plurality of third matrices.

14. The system of claim 10, wherein the performance metrics comprise one or more of: an amount of time to train each of the plurality of ML models, computation resource consumed while training each of the plurality of ML models, or power consumed while training plurality of ML models.

15. A non-transitory computer-readable storage medium storing instructions that, when executed by a processor, cause the processor to:
generate a plurality of first matrices and a plurality of first vectors;
create a plurality of second vectors from the plurality of first matrices and the plurality of first vectors;
train a machine learning (ML) model to predict output vectors for input data samples by applying the plurality of first matrices and the plurality of second vectors to an ML algorithm; and
predict an output vector for an input data sample by applying the input data sample to the trained ML model.

16. The non-transitory computer-readable storage medium of claim 15, wherein the plurality of first matrices and the plurality of first vectors are randomly generated.

17. The non-transitory computer-readable storage medium of claim 15, wherein the plurality of first matrices, the plurality of first vectors, and the plurality of second vectors corresponds to a dense system of linear equations, wherein the plurality of first matrices comprises coefficients of the system of linear equations, wherein the plurality of first vectors comprises variables of the system of linear equations, and wherein the plurality of second vectors comprises constant terms of the system of linear equations.

18. The non-transitory computer-readable storage medium of claim 15, wherein the instructions, when executed by a processor, further cause the processor to:
build a training data set by
transforming the plurality of first matrices and the plurality of second vectors to input training data by combining elements of the plurality of first matrices with elements of ones of the plurality of second vectors, and
for each first vector of the plurality of first vectors, generating and assigning a label to the respective first vector of the plurality of first vectors with a first matrix of the plurality of first matrices and a second vector of the plurality of second vectors, wherein the second vector is derived from the first matrix and the respective first vector,
wherein training the ML model comprises applying the input training data to the ML algorithm.

19. The non-transitory computer-readable storage medium of claim 18, wherein training the ML model further comprises:
predicting a plurality of output vectors based on applying the input training data to the ML algorithm;
measuring a similarity between the plurality of output vectors and the plurality of first vectors based on labels assigned to the plurality of first vectors; and
updating parameters of the ML algorithm based on the measured similarity.

20. The non-transitory computer-readable storage medium of claim 15, wherein the instructions, when executed by a processor, further cause the processor to:
determine a performance metric of training the ML model, wherein the performance metric comprises one or more of: an amount of time to train the ML model, computation resource consumed while training the ML model, or power consumed while training the ML model; and
set the performance metric as a performance benchmark.
